(19) United States
(12) Patent Application Publication
(10) Pub. No.: US 2016/0080536 A1
(43) Pub. Date: Mar. 17, 2016

(54) RECORDING MEDIUM, INFORMATION PROCESSING APPARATUS, AND INFORMATION PROCESSING SYSTEM

(71) Applicant: Ken Norota, Kanagawa (JP)

(72) Inventor: Ken Norota, Kanagawa (JP)

(73) Assignee: RICOH COMPANY, LTD., Tokyo (JP)

(21) Appl. No.: 14/853,378

(22) Filed: Sep. 14, 2015

(30) Foreign Application Priority Data
Sep. 16, 2014 (JP) 2014187363
Jul. 2, 2015 (JP) 2015133848

(51) Int. Cl. H04M 1/2745; H04W 4/00; H04W 76/02; H04W 12/06

(52) U.S. Cl. CPC H04M 1/274508; H04W 12/06; H04W 4/008; H04W 76/023; H04M 1/274533; H04M 1/274516

(57) ABSTRACT

A non-transitory computer-readable recording medium storing a computer-readable program that, when executed by an information processing apparatus to be connected with a device via communication protocols, causes the apparatus to serve as a detection unit that detects connection waiting information transmitted by the device within a communication area that enables communication via a first communication protocol; a determination unit that determines, when the detection unit detects the connection waiting information, whether the apparatus is to be connected with the device; a first information obtaining unit that connects, if the determination unit determines that the apparatus is to be connected with the device, with the device via the first communication protocol and obtains communication information to communicate with the device via a second communication protocol; and a second information obtaining unit that communicates with the device via the second communication protocol and obtains predetermined information from the device.

### CROSS-REFERENCE TO RELATED APPLICATIONS

The present application is based on and claims the benefit of priorities of Japanese Priority Application No. 2014-187363 filed on Sep. 16, 2014 and Japanese Priority Application No. 2015-133848 filed on Jul. 2, 2015, the entire contents of which are hereby incorporated by reference.

### BACKGROUND OF THE INVENTION

1. Field of the Invention

The present invention relates to a program, an information processing apparatus, and an information processing system.

2. Description of the Related Art

When various types of functions of an image formation apparatus are utilized from a mobile terminal, there is a technique of using Near Field Communication (NFC) in order to obtain communication information necessary to communicate with the image formation apparatus. In such a technique, the mobile terminal uses NFC to obtain the communication information and then the mobile terminal uses the communication information to utilize a print function of the image formation apparatus via Bluetooth (registered trademark) (see Patent Document 1, for example).

However, in the above-mentioned technique, a user of the mobile terminal needs to arrive in front of the image formation apparatus to which an NFC tag is attached, for example, in order to obtain the communication information. Further, since communication via Bluetooth does not have a high data transfer rate, it takes time to obtain information such as an address book from the image formation apparatus based on the obtained communication information. Accordingly, the user of the mobile terminal must wait in front of the image formation apparatus until the information about the address book is completely obtained after he held his own mobile terminal over the NFC tag.

### [Patent Document 1] Japanese Laid-Open Patent Application No. 2013-184296

### SUMMARY OF THE INVENTION

It is a general object of at least one embodiment of the present invention to provide support to obtain information from a device within a communication area that enables communication with the device.

In an embodiment, a non-transitory computer-readable recording medium storing a computer-readable program is provided. The program of the non-transitory computer-readable recording medium, when executed by an information processing apparatus to be connected with at least one device via a plurality of communication protocols, causes the information processing apparatus to serve as: a detection unit that detects connection waiting information transmitted by the device, the connection waiting information being transmitted within a communication area that enables communication via a first communication protocol; a determination unit that determines, when the detection unit detects the connection waiting information, whether the information processing apparatus is to be connected with the device that transmitted the connection waiting information; a first information obtaining unit that connects, if the determination unit determines that the information processing apparatus is to be connected with the device that transmitted the connection waiting information, with the device via the first communication protocol and obtains communication information to communicate with the device via a second communication protocol, the device being connected via the first communication protocol; and a second information obtaining unit that communicates with the device via the second communication protocol based on the communication information obtained by the first information obtaining unit, and obtains predetermined information from the device.

According to an embodiment of the present invention, it is possible to support obtainment of information from a device within a communication area that enables communication with the device.

### BRIEF DESCRIPTION OF THE DRAWINGS

Other objects and further features of embodiments will become apparent from the following detailed description when read in conjunction with the accompanying drawings, in which:

FIG. 1 is a configuration diagram of a FAX transmission system according to a first embodiment;

FIG. 2 is a hardware configuration diagram of a mobile terminal according to the first embodiment;

FIG. 3 is a hardware configuration diagram of an image formation apparatus according to the first embodiment;

FIG. 4 is an illustration of a process of a FAX transmission system according to the first embodiment;

FIG. 5 is a functional block diagram of a

FAX transmission system according to the first embodiment;

FIG. 6 is an illustration of communication information;

FIG. 7 is an illustration of address book information;

FIG. 8 is a sequence diagram of a process to obtain communication information in a FAX transmission system according to the first embodiment;

FIG. 9 is an illustration of a connection start confirmation screen;

FIG. 10 is an illustration of a PIN information input screen;

FIG. 11 is a sequence diagram of a process from address book information obtainment to FAX transmission in a FAX transmission system according to the first embodiment;

FIG. 12 is a functional block diagram of a FAX transmission system according to a second embodiment;

FIG. 13 is a sequence diagram of a process from address book information obtainment to FAX transmission in a FAX transmission system according to the second embodiment;

FIG. 14 is an illustration of address book information to be stored in a mobile terminal;

FIG. 15 is a flowchart of a process to delete address book information according to the second embodiment;

FIG. 16 is an illustration of a screen to select an address to be deleted;

FIG. 17 is a functional block diagram of a FAX transmission system according to a third embodiment;

FIG. 18 is a sequence diagram of a process to obtain communication information in a FAX transmission system according to the third embodiment; and

FIG. 19 is a flowchart of a process to delete address book information according to the third embodiment.

### DESCRIPTION OF THE PREFERRED EMBODIMENTS

In the following, embodiments of the present invention will be described in detail.

### First Embodiment

### <System Configuration>

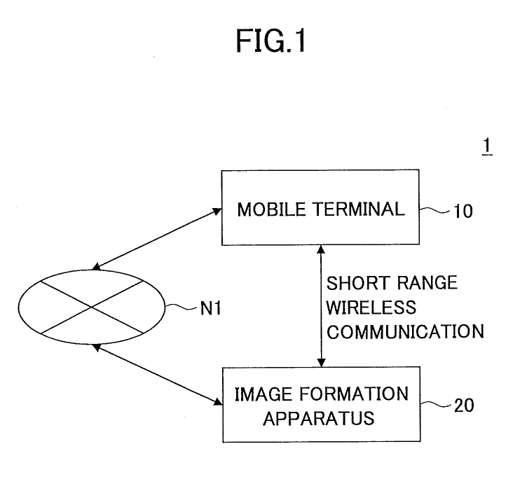

A system configuration of a FAX transmission system 1 according to a first embodiment is described. FIG. 1 is a configuration diagram of the FAX transmission system 1 according to the first embodiment.

The FAX transmission system 1 in FIG. 1 includes a mobile terminal 10 and at least one image formation apparatus 20 connected to a network N1 in a wired or a wireless manner. In particular, it is assumed that the mobile terminal 10 is connected to the network N1 in a wireless Local Area Network (LAN) such as Wi-Fi (registered trademark) or in mobile phone communication via a mobile phone network such as 3G/Long Term Evolution (LTE). In the present embodiment, the mobile terminal 10 is described based on the assumption that the mobile terminal 10 is connected to the network N1 in the wireless LAN. These wireless LAN and mobile phone communication systems are examples of using a second communication protocol described in the claims.

Further, the mobile terminal 10 and the image formation apparatus 20 are communicatively connected to each other via short range wireless communication. The short range wireless communication here is assumed to be communication provided by a communication standard such as Bluetooth Low Energy (BLE) or Bluetooth that enables communication in a distance from several to dozens of meters. Accordingly, the short range wireless communication according to the present embodiment does not include communication provided by a communication standard such as NFC that enables communication in a distance from several centimeters to one meter. In the present embodiment, the short range wireless communication is described on the assumption that the short range wireless communication is provided by BLE. Such short range wireless communication is an example of a first communication protocol described in the claims.

The mobile terminal 10 is an information processing apparatus such as a smartphone operated by a user. The mobile terminal 10 may also be a mobile phone, a tablet terminal, a game device, a PDA, or a digital camera. The mobile terminal 10 includes a BLE chip that functions as a BLE central as described later. In accordance with this, from the image formation apparatus 20, the user can obtain, via communication in BLE, communication information to perform communication with the image formation apparatus 20 via the network N1. Then, the mobile terminal 10 obtains information about an address book from the image formation apparatus 20 based on the obtained communication information. In accordance with this, the mobile terminal 10 can transmit, to the image formation apparatus 20, a FAX transmission job to send a FAX to a destination selected from the information about the address book.

The image formation apparatus 20 is a device such as a MultiFunction Peripheral (MFP) having a FAX transmission function. The image formation apparatus 20 includes a BLE chip that functions as a BLE peripheral as described later. In accordance with this, the image formation apparatus 20 transmits communication information to the mobile terminal 10 via communication in BLE. Further, the image formation apparatus 20 transmits information about an address book via the network N1 in response to a request from the mobile terminal 10. Further, the image formation apparatus 20 receives a FAX transmission job from the mobile terminal 10 and sends a FAX. In addition, the image formation apparatus 20 may have a plurality of functions such as a print function, a copy function, and a scanner function other than the FAX transmission function.

The FAX transmission system 1 mentioned above is an example and the FAX transmission system 1 may have a configuration including at least one mobile terminal 10 or a configuration including a job storage device to store a FAX transmission job. Further, the FAX transmission system 1 may have a configuration including a wireless LAN router or the like to connect the mobile terminal 10 to the network N1 via communication in a wireless LAN.

### <Hardware Configuration>

<<Mobile Terminal>>

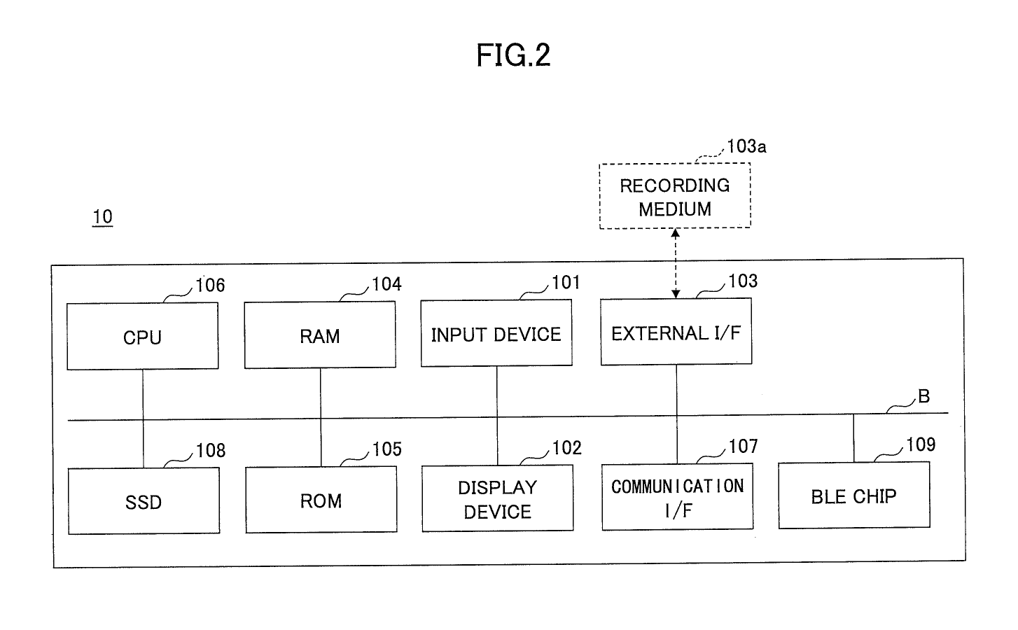

The mobile terminal 10 according to the first embodiment is implemented by a hardware configuration as shown in FIG. 2, for example. FIG. 2 is a hardware configuration diagram of the mobile terminal 10 according to the first embodiment.

The mobile terminal 10 shown in FIG. 2 includes an input device 101, a display device 102, an external I/F 103, a Random Access Memory (RAM) 104, a Read Only Memory (ROM) 105, a Central Processing Unit (CPU) 106, a communication I/F 107, a Solid State Drive (SSD) 108, a BLE chip 109, and the like, being connected to one other via a bus B.

The input device 101 is a touch panel, for example, and is used to input various types of operation signals to the mobile terminal 10. The input device 101 may be a keyboard or a mouse. The display device 102 is a Liquid Crystal Display (LCD), for example, and displays a process result from the mobile terminal 10.

The external I/F 103 is an interface for an external device. Examples of the external device include a recording medium 103a. The recording medium 103a can store a program to implement an embodiment. The mobile terminal 10 can read from and/or write to the recording medium 103a via the external I/F 103.

The recording medium 103a is such as an SD memory card, for example. The recording medium 103a may also be such as a Universal Serial Bus (USB) memory, a Digital Versatile Disk (DVD), a Compact Disk (CD), or a flexible disk.

The RAM 104 is a volatile semiconductor memory (storage device) that temporarily stores a program and data. The ROM 105 is a non-volatile semiconductor memory (storage device) capable of storing a program and data even in a powered-off state. The ROM 105 stores Basic Input/Output System (BIOS) executed when the mobile terminal 10 starts up, OS settings, and a program and data for network settings, for example.

The CPU 106 is an arithmetic unit that reads out a program and data from a storage device such as the ROM 105 and the SSD 108 onto the RAM 104 and executes a process so as to control the entire mobile terminal 10 and implement functions of the mobile terminal 10.

The communication I/F 107 is an interface to connect with the network N1 via a wireless LAN, for example. In accordance with this, the mobile terminal 10 can perform data communication via the communication I/F 107.

The SSD 108 is a non-volatile storage device that stores a program and data. Examples of the program and data to be stored include an Operating System (OS) serving as basic software to control the entire mobile terminal 10 and application software to provide various types of functions on the OS. The SSD 108 manages stored programs and data using a predetermined file system and/or a database (DB). In addition, the mobile terminal 10 may include a Hard Disk Drive (HDD) or the like instead of or together with the SSD 108.

The BLE chip 109 is a device that functions as a BLE central. The BLE chip 109 can communicate, in BLE, with the BLP chip included in the image formation apparatus 20 and functioning as a BLE peripheral.

The BLE peripheral here is a device that broadcasts information to indicate waiting for connection (connection waiting information) in a predetermined data format called advertisement packets. By contrast, the BLE central is a device that detects the connection waiting information broadcast by the BLE peripheral and sends a connection request to the BLE peripheral. In accordance with this, it is possible to perform communication in BLE between the BLE central and the BLE peripheral. In addition, since the image formation apparatus 20 continues to broadcast the connection waiting information as mentioned above, it is possible to reduce power consumption by using BLE as the first communication protocol as in the present embodiment.

The mobile terminal 10 according to the present embodiment can implement various types of processes as described below in accordance with the above-mentioned hardware configuration.

<<Image Formation Apparatus>>

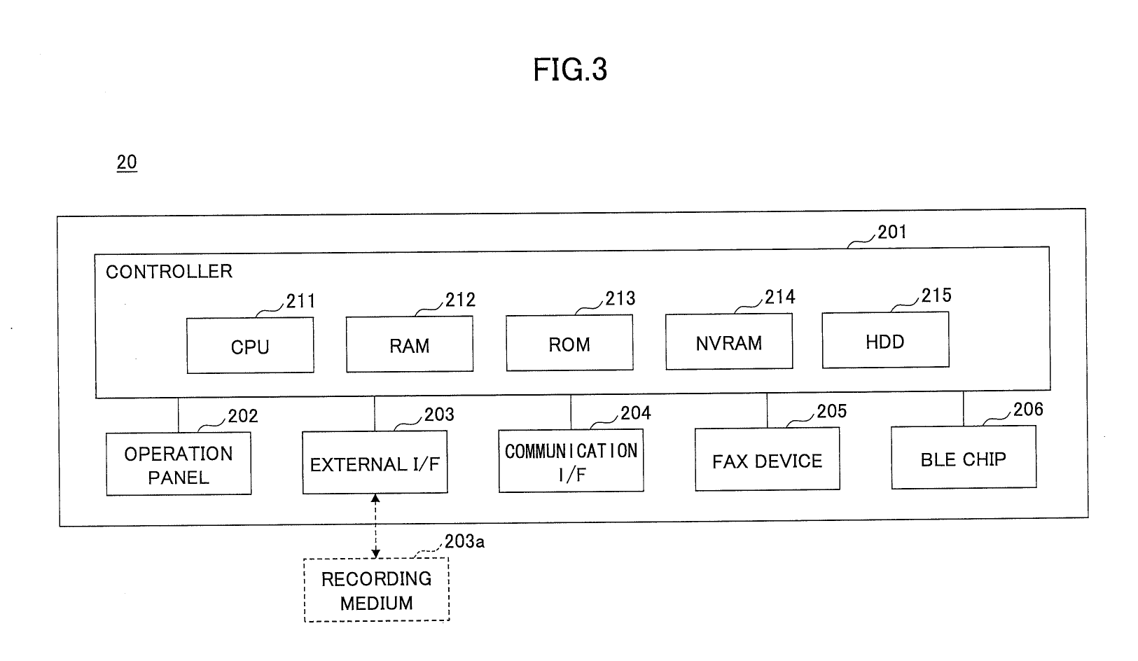

The image formation apparatus 20 according to the first embodiment is implemented by a hardware configuration as shown in FIG. 3, for example. FIG. 3 is a hardware configuration diagram of the image formation apparatus 20 according to the first embodiment.

The image formation apparatus 20 shown in FIG. 3 includes a controller 201, an operation panel 202, an external I/F 203, a communication I/F 204, a FAX device 205, and a BLE chip 206.

The controller 201 includes a CPU 211, a RAM 212, a ROM 213, an NVRAM 214, and an HDD 215. The ROM 213 stores various types of programs and data. The RAM 212 temporarily stores the program and data. The NVRAM 214 stores setting information and the like. The HDD 215 stores various types of programs and data.

The CPU 211 reads out a program, data, setting information, and the like from the ROM 213, the NVRAM 214, or the HDD 215 onto the RAM 212 and executes a process so as to control the entire image formation apparatus 20 and implement functions of the image formation apparatus 20.

The operation panel 202 includes an input device that receives an input from a user and a display device that performs display. The external I/F 203 is an interface for an external device. Examples of the external device include a recording medium 203a. In accordance with this, the image formation apparatus 20 can read from and/or write on the recording medium 203a via the external I/F 203. Examples of the recording medium 203a include a flexible disk, a CD, a DVD, an SD memory card, a USB memory, and the like.

The communication I/F 204 is an interface to connect the image formation apparatus 20 to the network N1. In accordance with this, the image formation apparatus 20 can perform data communication via the communication I/F 204. The FAX device 205 is a device to send a FAX.

The BLE chip 206 is a device that functions as a BLE peripheral. The BLE chip 206 can communicate, in BLE, with the BLE chip 109 included in the mobile terminal 10 and functioning as a BLE central.

The image formation apparatus 20 according to the present embodiment can implement various types of processes as described below in accordance with the above-mentioned hardware configuration.

### <Outline of Process>

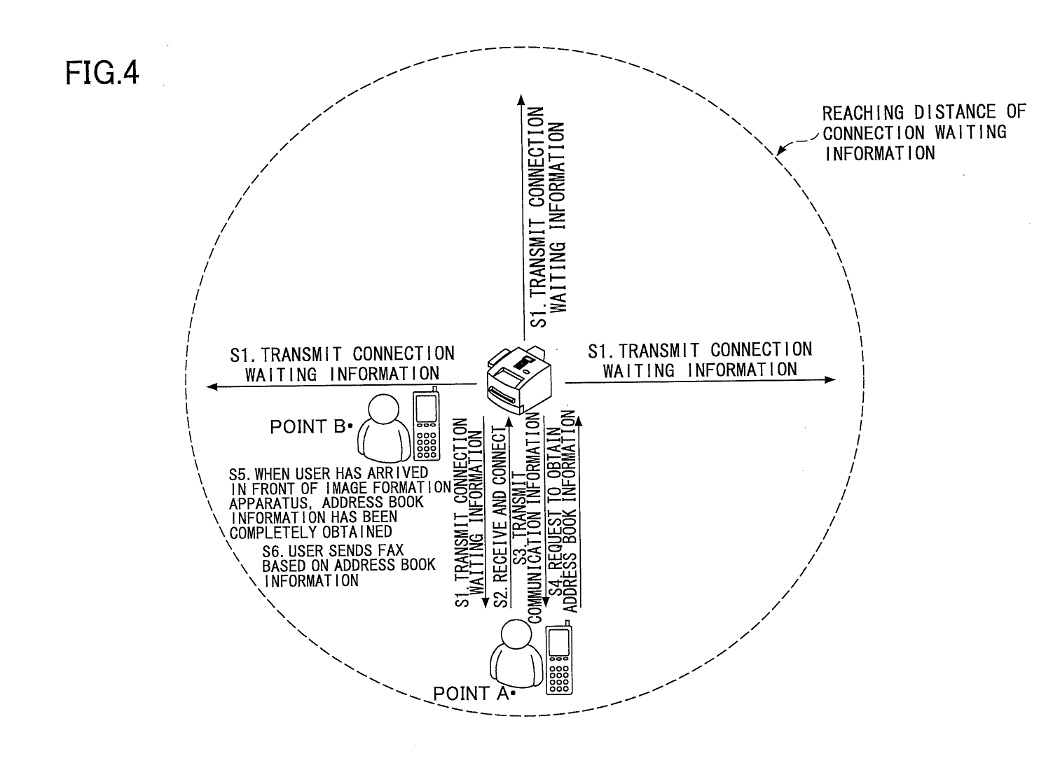

In the following, an outline of a process in the FAX transmission system 1 according to the first embodiment is described. FIG. 4 is an illustration of the process outline of the FAX transmission system 1 according to the first embodiment.

First, the image formation apparatus 20 is broadcasting connection waiting information in BLE (step S1). In other words, the BLE chip 206 of the image formation apparatus 20 is advertising. The image formation apparatus 20 transmits the connection waiting information such that the connection waiting information travels within an area of several meters around the image formation apparatus 20, for example. A reaching distance of this connection waiting information can be set where necessary by an administrative user or the like of the FAX transmission system 1.

If the mobile terminal 10 enters an area of the reaching distance (point A, for example) of the connection waiting information, the mobile terminal 10 detects the connection waiting information and connects with the image formation apparatus 20 in BLE (step S2). In accordance with this, the mobile terminal 10 and the image formation apparatus 20 can perform communication in BLE.

Next, the mobile terminal 10 obtains communication information from the image formation apparatus 20 via communication in BLE (step S3). Then the mobile terminal 10 connects with the image formation apparatus 20 via the network N1 using the obtained communication information and obtains address book information (step S4). The communication information here is information to communicate with the image formation apparatus 20 via the network N1 and includes an IP address of the image formation apparatus 20, for example.

In addition, the address book information is obtained through communication via the network N1 rather than communication in BLE because in general, address book information has a large data volume and wireless LAN communication having a high data transfer rate is more suitable for obtaining the address book information.

During the above-mentioned period, it is assumed that a user of the mobile terminal 10 has moved from the point A to a point B. When the user of the mobile terminal 10 has arrived in front of the image formation apparatus 20 (point B), the address book information has been completely obtained (step S5). However, depending on a volume of the address book information and a data transfer rate of the wireless LAN, the address book information may still be being obtained.

Accordingly, the user can send a FAX from the image formation apparatus 20 by using the mobile terminal 10 based on the obtained address book information without having to wait in front of the image formation apparatus 20 (step S6). In other words, the FAX transmission system 1 according to the present embodiment obtains the address book information to send a FAX while the user moves from a location where communication in BLE is possible to a location of the image formation apparatus 20. Accordingly, the user can send a FAX from the image formation apparatus 20 by promptly selecting a phone number from the address book information without having to wait in front of the image formation apparatus 20.

### <Functional Configuration>

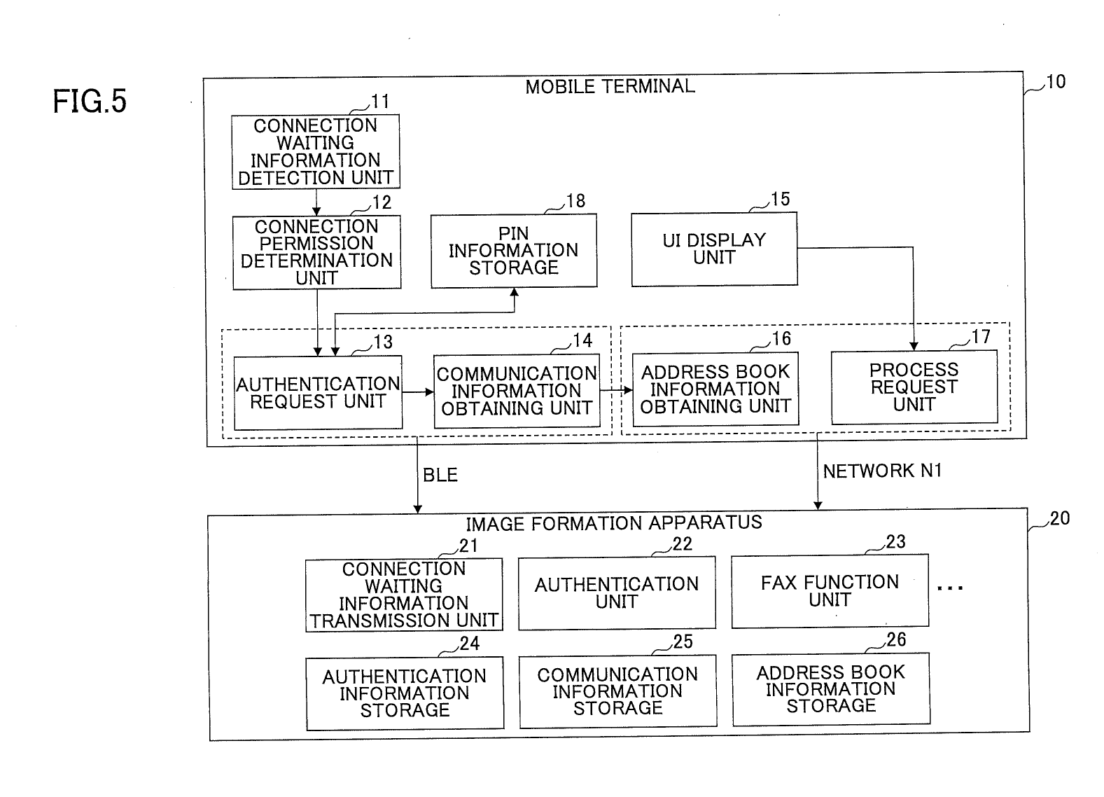

The FAX transmission system 1 according to the first embodiment is represented by functional blocks as shown in FIG. 5, for example. FIG. 5 is a functional block diagram of the FAX transmission system 1 according to the first embodiment.

<<Mobile Terminal>>

The mobile terminal 10 of the FAX transmission system 1 includes a connection waiting information detection unit 11, a connection permission determination unit 12, an authentication request unit 13, a communication information obtaining unit 14, a UI display unit 15, an address book information obtaining unit 16, a process request unit 17, and a Personal Identification Number (PIN) information storage 18, for example.

The connection waiting information detection unit 11 is implemented with the CPU 106, the BLE chip 109, and the like. The connection waiting information detection unit 11 detects reception of connection waiting information. In other words, the connection waiting information detection unit 11 detects the reception of the connection waiting information transmitted from a connection waiting information transmission unit 21 of the image formation apparatus 20 to be described below.

The connection permission determination unit 12 is implemented with the CPU 106 and the like. The connection permission determination unit 12 determines, if the reception of the connection waiting information is detected by the connection waiting information detection unit 11, whether to connect with the image formation apparatus 20 that transmitted the connection waiting information (namely, whether to perform communication in BLE).

The authentication request unit 13 is implemented with the CPU 106, the BLE chip 109, and the like. The authentication request unit 13 makes an authentication request by transmitting authentication information to the image formation apparatus 20 with which the connection permission determination unit 12 determined that connection is to be established. The authentication information includes at least PIN information and is used for an authentication process. The authentication information may be a pair of the PIN information and a user ID to uniquely identify a log-in user of the mobile terminal 10, for example.

The communication information obtaining unit 14 is implemented with the CPU 106, the BLE chip 109, and the like. If an authentication result in response to the authentication request by the authentication request unit 13 indicates successful authentication, the communication information obtaining unit 14 obtains communication information from the image formation apparatus 20 that authenticated the mobile terminal 10. The communication information is described in detail below.

The UI display unit 15 is implemented with the CPU 106, the display device 102, and the like. The UI display unit 15 generates and displays a User Interface (UI) screen.

The address book information obtaining unit 16 is implemented with the CPU 106, the communication I/F 107, and the like. The address book information obtaining unit 16 obtains address book information from the image formation apparatus 20 based on the communication information obtained by the communication information obtaining unit 14. The address book information is described in detail below.

The process request unit 17 is implemented with the CPU 106, the communication I/F 107, and the like. The process request unit 17 transmits a request for executing a FAX transmission job to the image formation apparatus 20, the FAX transmission job requesting sending a FAX to a phone number selected by the user based on the address book information.

The PIN information storage 18 is implemented with the ROM 105, the SSD 108, and the like. The PIN information storage 18 stores PIN information. The PIN information is a part of authentication information used to start communication with the image formation apparatus 20 in BLE. The PIN information includes a character string of specific alphanumeric characters, for example.

<<Image Formation Apparatus>>

The image formation apparatus 20 of the FAX transmission system 1 includes the connection waiting information transmission unit 21, an authentication unit 22, a FAX function unit 23, an authentication information storage 24, a communication information storage 25, and an address book information storage 26, for example.

The connection waiting information transmission unit 21 is implemented with the CPU 211, the BLE chip 206, and the like. The connection waiting information transmission unit 21 broadcasts connection waiting information. The connection waiting information here has a predetermined data format called advertisement packets as mentioned above.

Further, the connection waiting information includes information (such as a device ID or a production serial number) to uniquely identify the image formation apparatus 20 that transmits the connection waiting information and information about services to be provided by the image formation apparatus 20. Examples of the services to be provided include providing address book information.

The authentication unit 22 is implemented with the CPU 211 and the like. The authentication unit 22 performs an authentication process based on an authentication request transmitted from the mobile terminal 10.

The FAX function unit 23 is implemented with the FAX device 205 and the like. The FAX function unit 23 sends a FAX by executing a FAX transmission job for which the process request unit 17 of the mobile terminal 10 has made a request for execution. In addition to the FAX function unit 23, the image formation apparatus 20 may also have a print function unit that prints image data (electronic data) on a paper medium, a scan function unit that generates image data (electronic data) from a read manuscript, and a copy function unit that duplicates a read manuscript.

The authentication information storage 24 is implemented with the HDD 215 and the like. The authentication information storage 24 stores authentication information. The authentication information includes at least PIN information as mentioned above. Further, a pair of a user ID and the PIN information may be used as the authentication information.

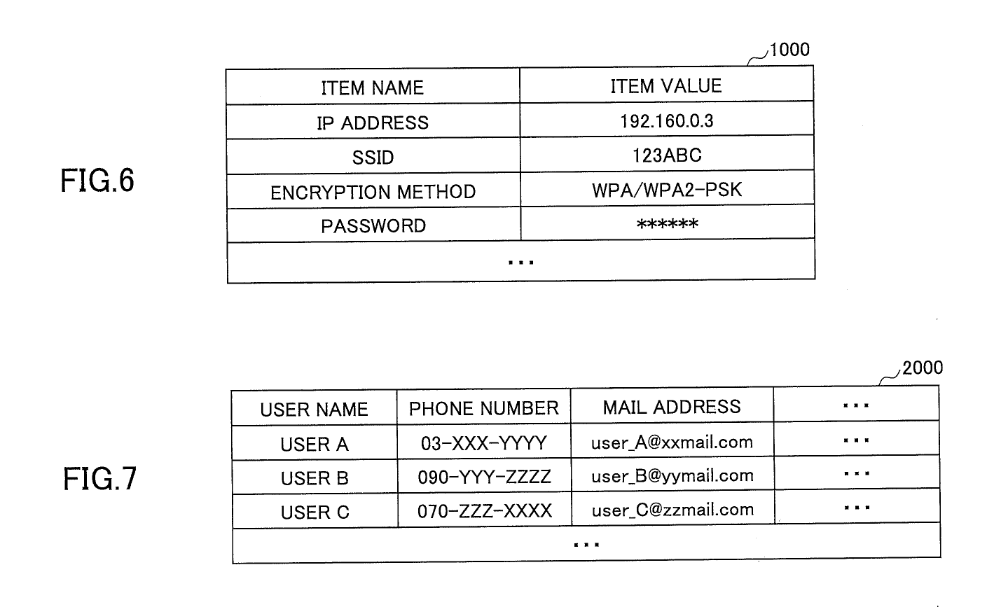

The communication information storage 25 is implemented with the HDD 215 and the like. The communication information storage 25 stores communication information 1000. The communication information 1000 here has a data structure as shown in FIG. 6, for example. FIG. 6 is an illustration of the communication information 1000.

The communication information 1000 has an “IP address” to identify the image formation apparatus 20, a “Service Set Identifier (SSID)” to identify the network N1 to which the mobile terminal 10 is connected, an “encryption method” to indicate a type of an encryption method of a wireless LAN in the network N1, and a “password” to authenticate the mobile terminal 10 in the network N1. The mobile terminal 10 can communicate with the image formation apparatus 20 via the network N1 when item values of these items are set as communication settings.

In addition, the communication information 1000 may have a port number of HyperText Transfer Protocol (HTTP) and a port number of HTTP over SSL/TLS (HTTPS) of the image formation apparatus 20 that are used in communication.

The address book information storage 26 is implemented with the HDD 215 and the like. The address book information storage 26 stores address book information 2000. The address book information 2000 here is information about users managed by the FAX transmission system 1. The address book information 2000 has a data structure as shown in FIG. 7, for example. FIG. 7 is an illustration of the address book information 2000.

The address book information 2000 has a “user name” to indicate a name of a user managed by the FAX transmission system 1, a “phone number” to indicate a phone number of the user, and a “mail address” to indicate an email address of the user. If the user of the mobile terminal 10 obtains the address book information 2000 from the image formation apparatus 20, the user can transmit to the image formation apparatus 20 a request to send a FAX to a phone number of user A, for example. In the same manner, the user of the mobile terminal 10 can transmit to the image formation apparatus 20 a request to transmit an email to a mail address of user B, for example. In this case, the user of the mobile terminal 10 may transmit, via FAX or email, electronic data generated by scanning in the image formation apparatus 20 or the user may transmit, via FAX or email, electronic data stored in the mobile terminal 10 or an external storage. In other words, the present embodiment can be applied to a case where email transmission is performed instead of FAX transmission in the same manner. Further, the present embodiment can also be applied to a case where the image formation apparatus 20 performs a predetermined process (to print an address, for example) based on information (such as an address) selected from the address book information 2000.

Further, the present embodiment is not limited to a system that performs an image formation process including FAX transmission. For example, the present embodiment can also be applied to a system that uses various types of devices such as a projector, an electronic whiteboard, and digital signage instead of the image formation apparatus 20.

For example, if a screen is to be shared among a plurality of electronic whiteboards, the user uses the mobile terminal 10 and obtains, from a first electronic whiteboard, address book information about a second electronic whiteboard that can share a screen with the first electronic whiteboard. Then the user selects the second electronic whiteboard as a source of the screen sharing (namely, as a host) from the mobile terminal 10. In accordance with this, when the user has arrived in front of the first electronic whiteboard, an operation to search for or select the second electronic whiteboard which is the source of the screen sharing is unnecessary. Accordingly, in this case, operations of the user after the user has arrived in front of the first electronic whiteboard are reduced.

### <Detail of Process>

In the following, a process of the FAX transmission system 1 according to the present embodiment is described in detail.

<<Process to Obtain Communication Information>>

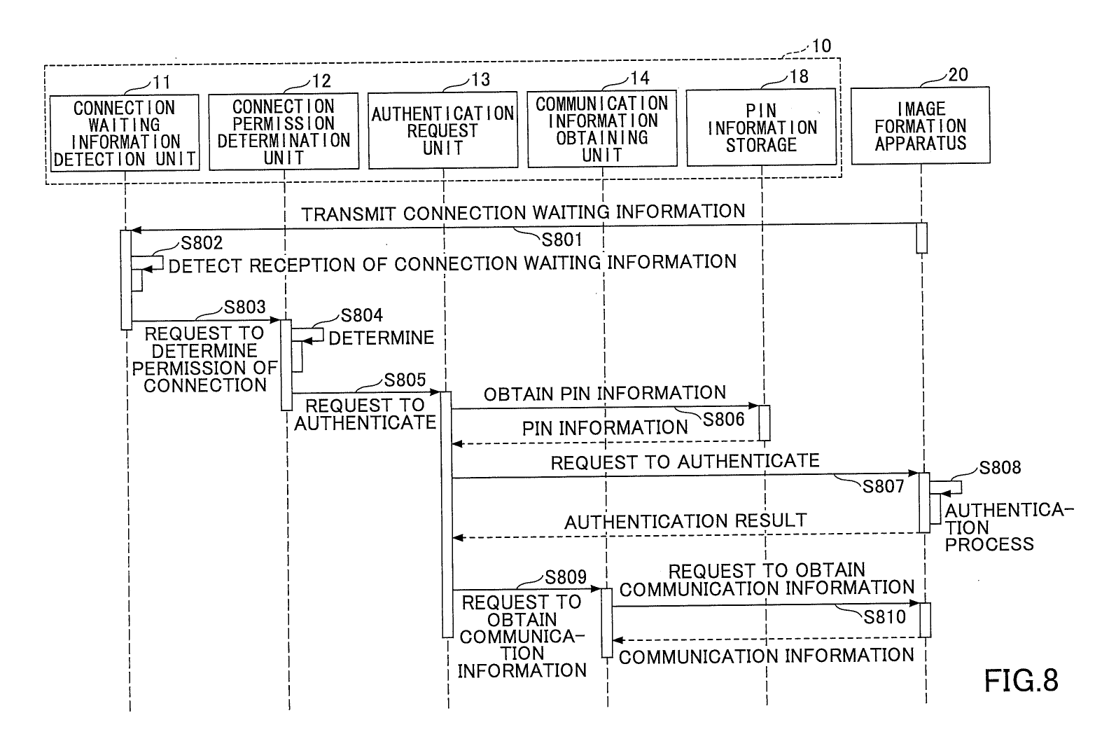

A process to obtain communication information by the mobile terminal 10 from the image formation apparatus 20 is described. In other words, a process from step S1 to step S3 in <Outline of process>above is described. FIG. 8 is a sequence diagram of a process to obtain communication information in the FAX transmission system 1 according to the first embodiment.

The connection waiting information transmission unit 21 of the image formation apparatus 20 is transmitting (multi-address transmission; broadcasting) connection waiting information within a predetermined area (namely, within a communication area that enables communication in BLE) (step S801).

The connection waiting information here includes information (such as a device ID or a production serial number) to uniquely identify the image formation apparatus 20 that transmits the connection waiting information and information about services to be provided by the image formation apparatus 20. Examples of the services to be provided include providing address book information.

When the connection waiting information detection unit 11 of the mobile terminal 10 receives the connection waiting information, the connection waiting information detection unit 11 detects the reception of the connection waiting information (step S802). Since the image formation apparatus 20 is transmitting the connection waiting information within the predetermined area around the image formation apparatus 20, the mobile terminal 10 receives the connection waiting information upon entering the predetermined area. In this case, the connection waiting information detection unit 11 of the mobile terminal 10 detects the reception of the connection waiting information.

When the connection waiting information detection unit 11 of the mobile terminal 10 detects the reception of the connection waiting information, the connection waiting information detection unit 11 sends, to the connection permission determination unit 12, a request to determine whether to perform communication in BLE with the image formation apparatus 20 that transmitted the connection waiting information (step S803).

If different image formation apparatuses 20 transmit relevant connection waiting information and the mobile terminal 10 receives the relevant connection waiting information, the connection waiting information detection unit 11 sends, to the connection permission determination unit 12, a request to determine which of the image formation apparatuses 20 communication is to be performed with in BLE. Examples of this includes such a case where the mobile terminal 10 receives both connection waiting information A transmitted from an image formation apparatus 20-1 and connection waiting information B transmitted from an image formation apparatus 20-2.

The connection permission determination unit 12 of the mobile terminal 10 determines whether to perform communication in BLE with the image formation apparatus 20 that transmitted the connection waiting information (step S804). The connection permission determination unit 12 sends an authentication request to the authentication request unit 13 in accordance with a determination result (step S805). In other words, if the connection permission determination unit 12 determines that communication in BLE is to be performed with the image formation apparatus 20 that transmitted the connection waiting information, the connection permission determination unit 12 sends an authentication request to the authentication request unit 13.

In the following, it is assumed that the connection permission determination unit 12 has a determination result to indicate that communication in BLE is to be performed with any of the image formation apparatuses 20 that transmitted the connection waiting information. If the connection permission determination unit 12 has a determination result to indicate that communication in BLE is not to be performed with any of the image formation apparatuses 20 that transmitted the connection waiting information, the display device 102 of the mobile terminal 10 displays a screen to indicate that communication in BLE is impossible.

In step S804, the connection permission determination unit 12 may determine as described in (1)-(3), for example.

(1) The connection permission determination unit 12 determines that communication in BLE is to be performed with an image formation apparatus 20 set in advance.

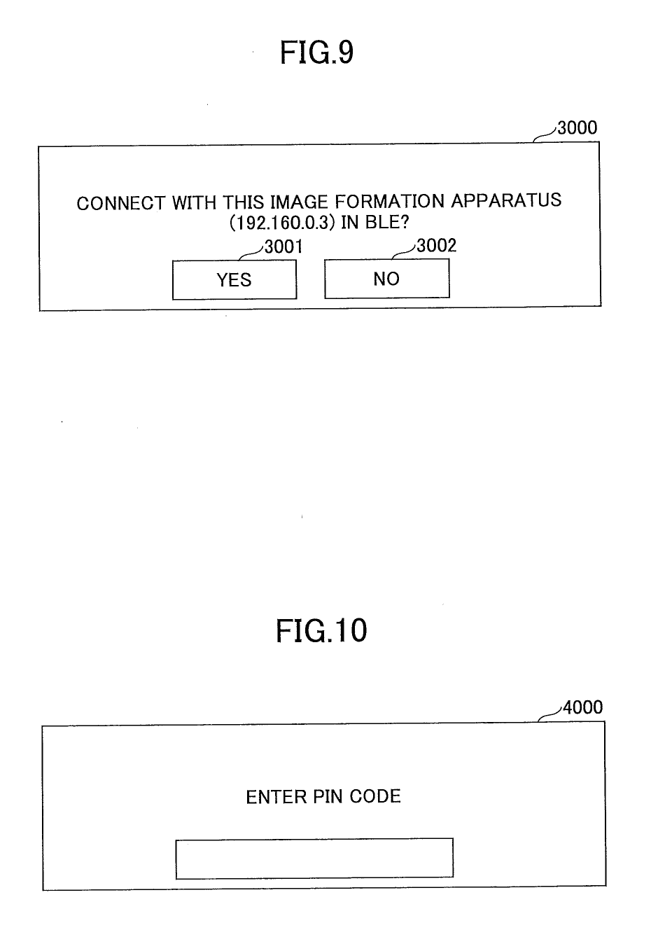

(2) If the connection waiting information detection unit 11 detects reception of the connection waiting information, the UI display unit 15 of the mobile terminal 10 displays a connection start confirmation screen 3000 as shown in FIG. 9, for example. On the connection start confirmation screen 3000, if the user selects a connection permission button 3001, the connection permission determination unit 12 determines that communication in BLE is to be performed with the image formation apparatus 20 that transmitted the connection waiting information. By contrast, if the user selects a connection refusal button 3002, the connection permission determination unit 12 determines that communication in BLE is not to be performed with the image formation apparatus 20 that transmitted the connection waiting information.

(3) If the connection waiting information detection unit 11 detects reception of a plurality of sets of connection waiting information, the connection permission determination unit 12 determines that communication in BLE is to be performed with an image formation apparatus 20 closest to the mobile terminal 10.

When the authentication request unit 13 of the mobile terminal 10 receives the authentication request from the connection permission determination unit 12, the authentication request unit 13 obtains PIN information from the PIN information storage 18 (step S806). Then the authentication request unit 13 of the mobile terminal 10 makes an authentication request by transmitting authentication information including the PIN information to the image formation apparatus 20 with which the connection permission determination unit 12 determined that communication in BLE is to be performed (step S807).

In addition, in step S806 above, the authentication request unit 13 may obtain PIN information input by the user rather than to obtain the PIN information from the PIN information storage 18. For example, the UI display unit 15 displays a PIN information input screen 4000 as shown in FIG. 10. The authentication request unit 13 may obtain the PIN information input by the user on the PIN information input screen 4000 and make an authentication request by transmitting authentication information including this obtained PIN information to the image formation apparatus 20. In accordance with this, it is possible to improve security because the PIN information is not stored in the mobile terminal 10.

When the authentication unit 22 of the image formation apparatus 20 receives the authentication request from the mobile terminal 10, the authentication unit 22 performs an authentication process (step S808). In other words, the authentication unit 22 refers to the authentication information storage 24 and determines whether the same authentication information as received from the mobile terminal 10 is stored in the authentication information storage 24.

For example, the authentication unit 22 determines whether the same PIN information as included in the authentication information received from the mobile terminal 10 is stored in the authentication information storage 24. If the same PIN information as included in the authentication information received from the mobile terminal 10 is stored in the authentication information storage 24, the authentication unit 22 of the image formation apparatus 20 transmits an authentication result to indicate successful authentication to the authentication request unit 13 of the mobile terminal 10. By contrast, if the same PIN information as included in the authentication information is not stored in the authentication information storage 24, the authentication unit 22 transmits an authentication result to indicate failed authentication to the authentication request unit 13 of the mobile terminal 10.

In the following, it is assumed that the authentication unit 22 of the image formation apparatus 20 transmits the authentication result to indicate successful authentication to the authentication request unit 13 of the mobile terminal 10. In addition, if the authentication unit 22 of the image formation apparatus 20 transmits the authentication result to indicate failed authentication to the authentication request unit 13 of the mobile terminal 10, the display device 102 of the mobile terminal 10 displays a screen to show that the authentication has failed, for example.

When the authentication request unit 13 of the mobile terminal 10 receives the authentication result from the authentication unit 22 of the image formation apparatus 20, the authentication request unit 13 sends a request to obtain communication information to the communication information obtaining unit 14 (step S809).

When the communication information obtaining unit 14 of the mobile terminal 10 receives the request to obtain communication information from the authentication request unit 13, the communication information obtaining unit 14 sends a request to obtain communication information to the relevant image formation apparatus 20 via communication in BLE (step S810). Then the image formation apparatus 20 transmits the communication information 1000 stored in the communication information storage 25 to the mobile terminal 10.

In accordance with this, the mobile terminal 10 according to the present embodiment can obtain the communication information from the image formation apparatus 20 via communication in BLE. Such a process to obtain communication information starts when the user enters the communication area that enables communication in BLE while the user carries the mobile terminal 10.

<<Process from Address Book Information Obtainment to FAX Transmission>>

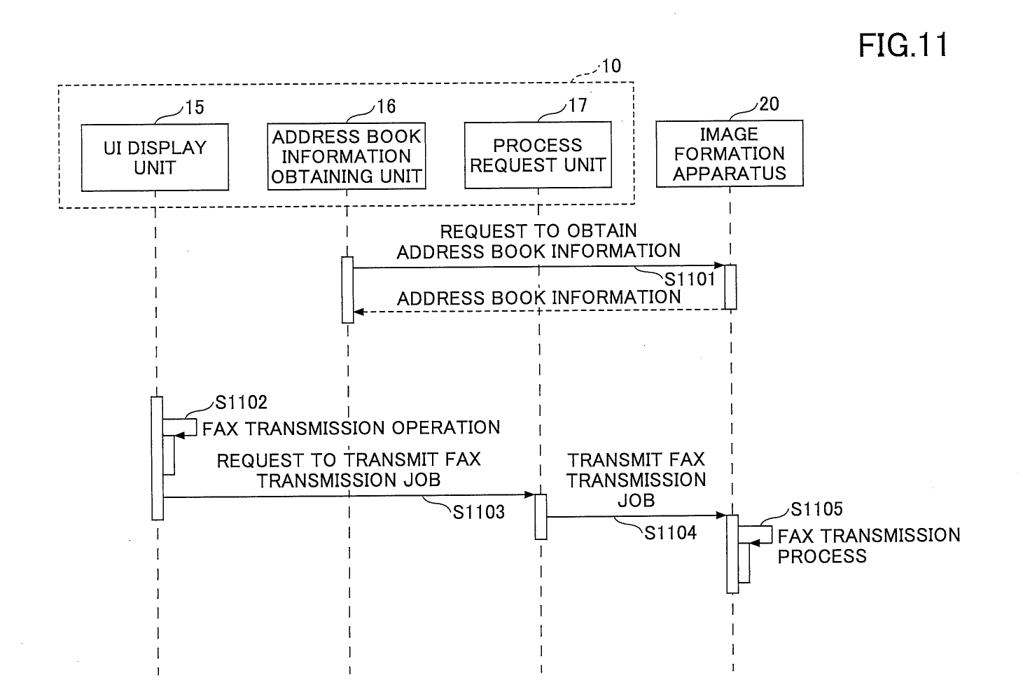

In the following, a process where the mobile terminal 10 obtains address book information and sends a FAX from the image formation apparatus 20 is described. In other words, a process from step S4 to step S6 in <Outline of process>above is described. FIG. 11 is a sequence diagram of the process from address book information obtainment to FAX transmission in the FAX transmission system 1 according to the first embodiment.

When the communication information obtaining unit 14 obtains the communication information 1000 of the image formation apparatus 20, the address book information obtaining unit 16 of the mobile terminal 10 connects with the network N1 in the wireless LAN. The address book information obtaining unit 16 obtains the address book information 2000 stored in the address book information storage 26 of the image formation apparatus 20 indicated by an IP address included in the communication information 1000 (step S1101).

In addition, in step S1101, the UI display unit 15 of the mobile terminal 10 may display a screen to obtain only a necessary part of the address book information 2000 and relevant address book information 2000 may be obtained based on an input or selection on this screen. For example, only a record of user names whose initial character is “A” in the address book information 2000 may be obtained by an input or selection by the user. In accordance with this, it is possible to reduce an amount of data communication required to obtain the address book information 2000.

In this manner, the mobile terminal 10 obtains the address book information 2000 from the image formation apparatus 20. In accordance with this, the user of the mobile terminal 10 can transmit a FAX transmission job to the image formation apparatus 20 using the obtained address book information 2000.

It is assumed here that the user carrying the mobile terminal 10 has been moving toward the relevant image formation apparatus 20 since the user entered the communication area that enables communication in BLE until the address book information 2000 is obtained. When the user carrying the mobile terminal 10 has arrived in front of the image formation apparatus 20, the address book information 2000 has been completely obtained, so that the user can immediately perform a FAX transmission operation.

However, depending on a data volume of the address book information 2000 and a data transfer rate of the network N1, for example, the address book information 2000 may still be in the process of being obtained when the user has arrived in front of the image formation apparatus 20. However, even in this case, waiting time for the user to perform the FAX transmission operation is reduced.

Subsequently, the user of the mobile terminal 10 performs the FAX transmission operation from a predetermined screen displayed on the UI display unit 15 (step S1102). In other words, the UI display unit 15 generates and renders a screen where a list of user names and phone numbers is displayed based on the obtained address book information 2000, for example. The user selects the phone number of a desired user name from the list and performs the FAX transmission operation. In accordance with this, a FAX transmission job is created in the mobile terminal 10. In this case, electronic data to be transmitted by FAX may be selected from the mobile terminal 10 or an external storage.

When the FAX transmission operation is performed by the user, the UI display unit 15 of the mobile terminal 10 sends to the process request unit 17 a request to transmit the FAX transmission job (step S1103).

When the process request unit 17 of the mobile terminal 10 receives the request to transmit the FAX transmission job from the UI display unit 15, the process request unit 17 transmits the FAX transmission job to the image formation apparatus 20 via the network N1 (step S1104).

When the image formation apparatus 20 receives the FAX transmission job from the process request unit 17 of the mobile terminal 10, the image formation apparatus 20 becomes capable of sending a FAX to the phone number included in the FAX transmission job. If the user operates the operation panel 202 of the image formation apparatus 20 to read a manuscript to be sent by FAX and generate electronic data, the FAX function unit 23 sends the electronic data by FAX to the phone number included in the FAX transmission job (step S1105).

In step S1104, if the mobile terminal 10 supports NFC, for example, the FAX transmission job may be transmitted to the image formation apparatus 20 when the user brings the mobile terminal 10 close to the image formation apparatus 20 and communication in NFC starts. In accordance with this, the user can perform FAX transmission while the user has sufficiently approached the desired image formation apparatus 20.

Further, whether the user has approached the image formation apparatus 20 may be determined based on radio wave intensity using Bluetooth, for example, received by the mobile terminal 10 from the image formation apparatus 20. If it is determined that the user has approached the image formation apparatus 20, the FAX transmission job may be transmitted. In accordance with this, the user can perform FAX transmission while the user has sufficiently approached the desired image formation apparatus 20 in the same manner as mentioned above.

In accordance with this, the user of the FAX transmission system 1 can send a FAX to the address selected from the mobile terminal 10.

### Second Embodiment

In the following, the FAX transmission system 1 according to a second embodiment is described. In the second embodiment, a difference from the first embodiment is described and elements having the same functional configuration as in the first embodiment will be given the same reference numerals as used in the first embodiment, so that a description of such elements will be omitted.

In the second embodiment, address book information obtained from the image formation apparatus 20 is associated with the image formation apparatus 20 and stored in a non-volatile storage area of the mobile terminal 10 such as the SSD 108. Further, when the user ends the use of the image formation apparatus 20 and moves away from the image formation apparatus 20, the address book information stored in the mobile terminal 10 will be deleted.

In accordance with this, it is possible to clearly delete the address book information stored in the mobile terminal 10 when the user ends the use of the image formation apparatus 20. Accordingly, in the mobile terminal 10 according to the present embodiment, it is possible to prevent unnecessary address book information from being stored in the mobile terminal 10 after the use of the image formation apparatus 20 ends.

### <Functional Configuration>

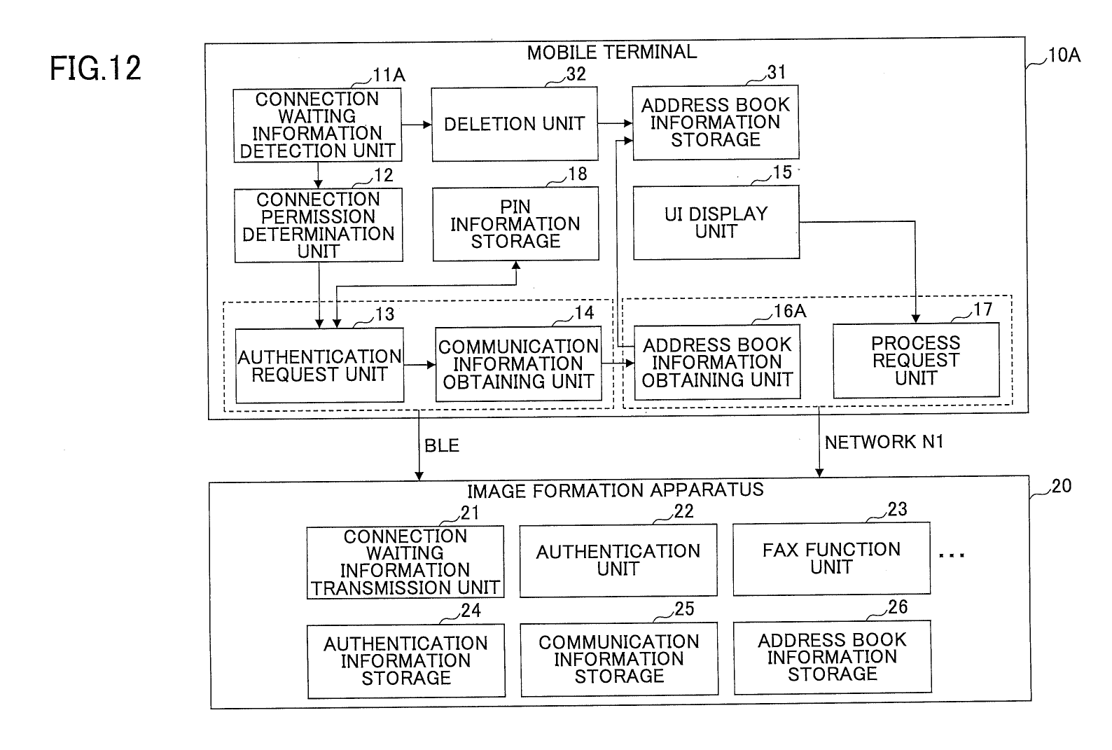

The FAX transmission system 1 according to the second embodiment is represented by functional blocks as shown in FIG. 12, for example. FIG. 12 is a functional block diagram of the FAX transmission system 1 according to the second embodiment.

A mobile terminal 10A according to the second embodiment includes a connection waiting information detection unit 11A, an address book information obtaining unit 16A, an address book information storage 31, and a deletion unit 32.

The connection waiting information detection unit 11A reports that reception of connection waiting information is detected to the deletion unit 32.

The address book information obtaining unit 16A associates obtained address book information with information to identify the image formation apparatus 20 (hereafter “device ID”) and stores the associated information in the address book information storage 31.

The address book information storage 31 is implemented with the SSD 108 and the like. The address book information storage 31 stores address book information 5000 in which the address book information 2000 is associated with the device ID. The address book information 5000 is described in detail below.

The deletion unit 32 is implemented with the CPU 106 and the like. The deletion unit 32 deletes the address book information 5000 stored in the address book information storage 31 when the user moves away from the image formation apparatus 20. In other words, the deletion unit 32 deletes the address book information 5000 when the user ends the use of the image formation apparatus 20 and moves away from the image formation apparatus 20. In accordance with this, in the mobile terminal 10A according to the present embodiment, the address book information 5000 is clearly deleted, so that it is possible to prevent unnecessary address book information from being stored.

### <Detail of Process>

In the following, a process of the FAX transmission system 1 according to the second embodiment is described in detail. Since the second embodiment has the same process to obtain communication information as in the first embodiment, a description thereof is omitted.

<<Process from Address Book Information Obtainment to FAX Transmission>>

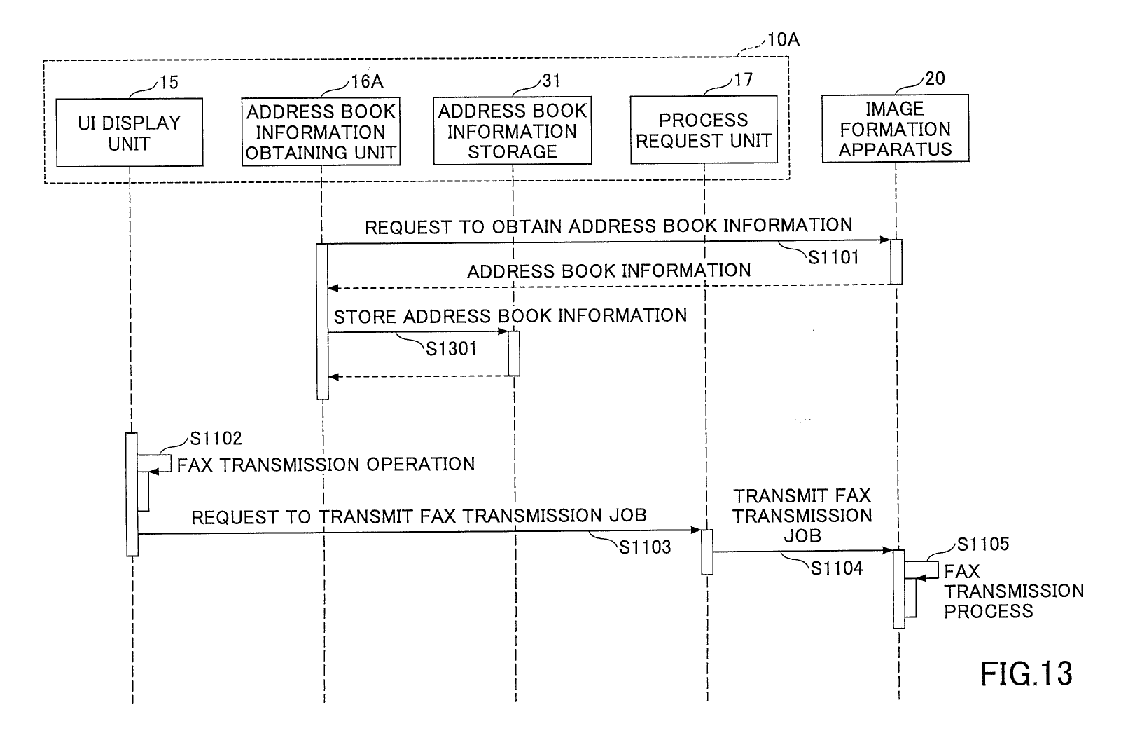

In the following, a process from address book information obtainment to FAX transmission according to the second embodiment is described. FIG. 13 is a sequence diagram of the process from address book information obtainment to FAX transmission in the FAX transmission system 1 according to the second embodiment.

When the address book information obtaining unit 16A receives the address book information 2000 from the image formation apparatus 20, the address book information obtaining unit 16A stores, in the address book information storage 31, the address book information 5000 in which the device ID of the image formation apparatus 20 is associated with the address book information 2000 (step S1301).

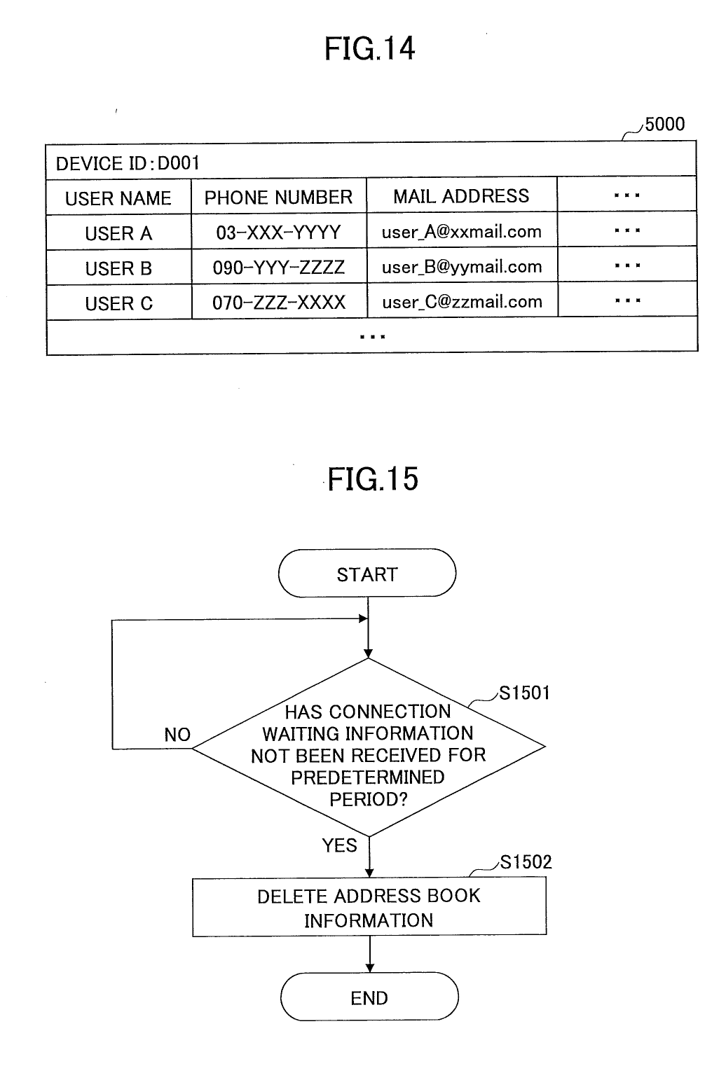

The address book information 5000 here is described with reference to FIG. 14. FIG. 14 is an illustration of the address book information 5000 to be stored in the mobile terminal 10A.

As shown in FIG. 14, the address book information 5000 to be stored in the address book information storage 31 includes information in which the device ID of the image formation apparatus 20 is associated with the address book information 2000.

The device ID in the address book information 5000 may be a device ID included in connection waiting information received from the image formation apparatus 20 in step S801 shown in FIG. 8, for example. However, the device ID is not limited to this. For example, the device ID may be obtained together with the address book information 2000 in step 51101 shown in FIG. 13 and this device ID may be associated with the address book information 2000.

Further, while FIG. 14 shows one set of the address book information 5000, a plurality of sets of address book information may be stored in the address book information storage 31. For example, one address book information set associated with a device ID “D001” and another address book information set associated with a device ID “D002” may be stored.

As mentioned above, in the mobile terminal 10A of the present embodiment, the address book information 5000 in which the address book information 2000 is associated with the device ID is stored in a storage area of the mobile terminal 10A.

<<Process to Delete Address Book Information>>

The following describes a process to delete the address book information 5000 stored in the mobile terminal 10A according to the present embodiment when the user ends the use of the image formation apparatus 20. FIG. 15 is a flowchart of the process to delete the address book information 5000 according to the second embodiment.

The deletion unit 32 of the mobile terminal 10A determines whether the deletion unit 32 has not received connection waiting information from the image formation apparatus 20 for a predetermined period (step S1501). In other words, the deletion unit 32 determines whether the deletion unit 32 has not received, for a predetermined period, a report to indicate that reception of connection waiting information is detected by the connection waiting information detection unit 11A.

In this case, the image formation apparatus 20 is transmitting the connection waiting information within a predetermined area around the image formation apparatus 20 as described above. Accordingly, while the user uses the image formation apparatus 20, the connection waiting information detection unit 11A of the mobile terminal 10A reports that reception of the connection waiting information is detected to the deletion unit 32 each time the connection waiting information detection unit 11A receives the connection waiting information. When the user ends the use of the image formation apparatus 20 and moves away from the predetermined area, the mobile terminal 10A does not receive the connection waiting information.

Accordingly, if the deletion unit 32 has not received the connection waiting information from the image formation apparatus 20 for a predetermined period, this means that the user has ended the use of the image formation apparatus 20 and moved away from the image formation apparatus 20 (moved out of the predetermined area).

If it is determined that the connection waiting information has not been received from the image formation apparatus 20 for a predetermined period in step S1501 (S1501 YES), the deletion unit 32 deletes the address book information 5000 from the address book information storage 31 (step S1502).

In this case, the connection waiting information includes a device ID as mentioned above. Accordingly, the deletion unit 32 may delete the address book information 5000 that has a device ID included in connection waiting information that has not been received for a predetermined period. For example, in a case where the address book information storage 31 stores a first address book information set having the device ID “D001” and a second address book information set having the device ID “D002”, if connection waiting information including the device ID “D001” has not been received for a predetermined period, the first address book information set having the device ID “D001” may be deleted.

Further, in step S1502, the deletion unit 32 may delete only a record selected by the user from records included in the address book information 5000.

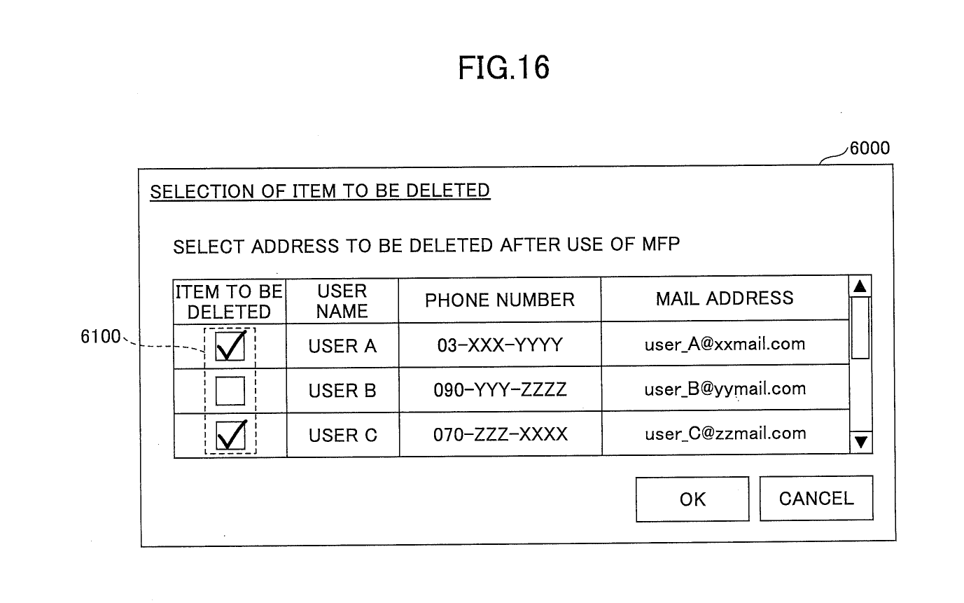

In other words, when the mobile terminal 10A stores the address book information 5000 in step S1301, the mobile terminal 10A causes the UI display unit 15 to display a screen 6000 to select an address to be deleted as shown in FIG. 16, for example. Then the deletion unit 32 may delete a record corresponding to an address selected to be deleted by checking a check box 6100 on the screen 6000 to select an address to be deleted. In accordance with this, the user can delete only an address that the user does not wish to save in the mobile terminal 10A.

In addition, on the screen 6000 to select an address to be deleted shown in FIG. 16, the user selects an address to be deleted by checking the check box 6100. However, deletion is not limited to box like this. For example, when the screen 6000 to select an address to be deleted is displayed first, all of the check boxes 6100 may be checked. In this case, the user may select an address to be saved in the mobile terminal 10 by un-checking the check box 6100. In accordance with this, the user can save only a necessary address that may be used repeatedly, for example, in the mobile terminal 10A.

Further, the deletion unit 32 may save a record corresponding to an address selected (namely, used) in the FAX transmission operation in step S1102 shown in FIG. 11 among records included in the address book information 5000, for example.

In the present embodiment, the user of the mobile terminal 10 can select a record to be deleted from the address book information in step S1502 above. However, the selection of the record may be made by an administrator of the FAX transmission system 1 or the like. In other words, the screen 6000 to select an address to be deleted shown in FIG. 16 above may be displayed on the operation panel 202 of the image formation apparatus 20 and the administrator may select a record that the administrator does not wish to save in the mobile terminal 10. In accordance with this, the administrator of the FAX transmission system 1 can delete a record of the address book information that the administrator does not wish to save in the mobile terminal 10 in terms of security.

In this case, in step S1101, for example, in addition to the address book information 2000, the image formation apparatus 20 may transmit, to the mobile terminal 10, information to indicate a record to be deleted from the address book information 2000.

### Third Embodiment

In the following, the FAX transmission system 1 according to a third embodiment is described. In the third embodiment, a difference from the second embodiment is described and elements having the same functional configuration as in the second embodiment will be given the same reference numerals as used in the second embodiment, so that a description of such elements will be omitted.

In the third embodiment, communication information is obtained and the address book information 5000 is deleted based on a distance between the mobile terminal 10 and the image formation apparatus 20. In other words, if the distance between the mobile terminal 10 and the image formation apparatus 20 is not more than a first threshold, the mobile terminal 10 obtains communication information from the image formation apparatus 20. Further, if the distance between the mobile terminal 10 and the image formation apparatus 20 is not less than a second threshold, the mobile terminal 10 deletes address book information from the storage area.

### <Functional Configuration>

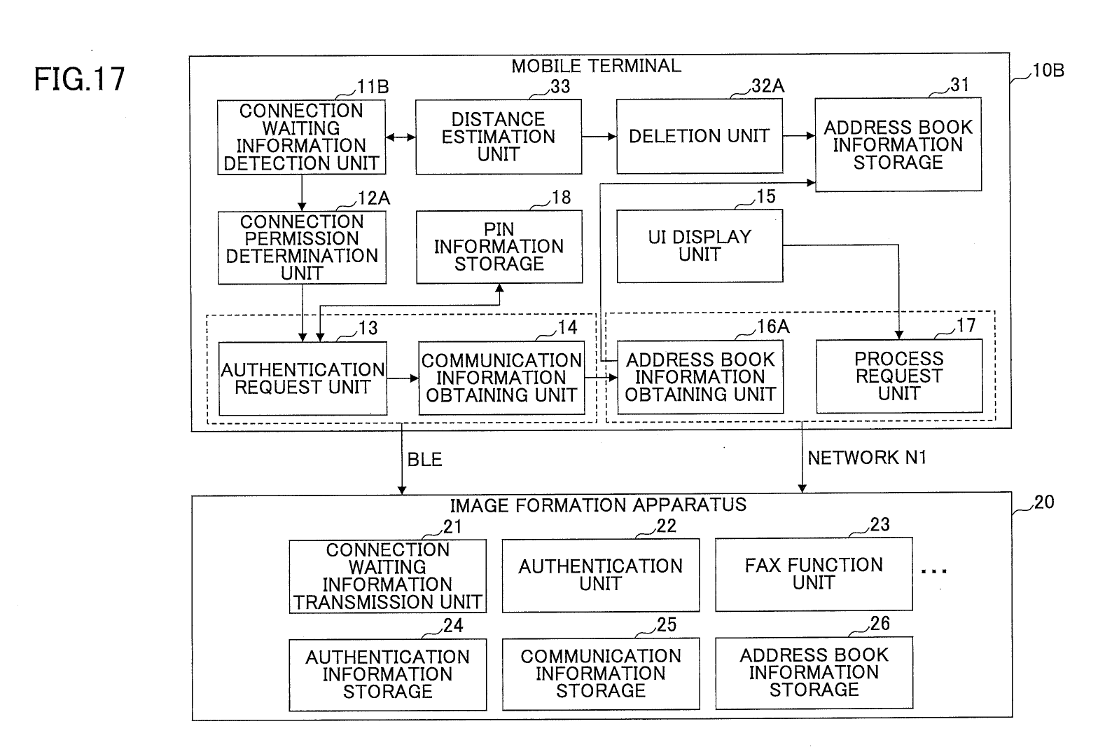

The FAX transmission system 1 according to the third embodiment is represented by functional blocks as shown in FIG. 17, for example. FIG. 17 is a functional block diagram of the FAX transmission system 1 according to the third embodiment.

A mobile terminal 10B according to the third embodiment includes a connection waiting information detection unit 11B, a connection permission determination unit 12A, a deletion unit 32A, and a distance estimation unit 33.

The connection waiting information detection unit 11B sends, if reception of connection waiting information is detected, a request to estimate a distance based on received connection waiting information to the distance estimation unit 33.

The connection permission determination unit 12A determines, based on a distance estimated by the distance estimation unit 33, whether to connect with the image formation apparatus 20 that transmitted the connection waiting information. In other words, if the distance estimated by the distance estimation unit 33 is not more than the first threshold set in advance, the connection permission determination unit 12A determines that communication in BLE is to be performed with the image formation apparatus 20 that transmitted the connection waiting information.

The deletion unit 32A deletes, based on the distance estimated by the distance estimation unit 33, the address book information 5000 stored in the address book information storage 31. In other words, if the distance estimated by the distance estimation unit 33 is not less than the second threshold set in advance, the deletion unit 32A deletes the address book information 5000 stored in the address book information storage 31.

The distance estimation unit 33 estimates, based on connection waiting information received from the image formation apparatus 20, a distance between the mobile terminal 10B and the image formation apparatus 20.

It is possible to estimate the distance here based on reception intensity (RSSI: Received Signal Strength Indication) when the mobile terminal 10B receives the connection waiting information and intensity of radio wave output (Tx Power Level) of the image formation apparatus 20 included in the connection waiting information, for example. The distance estimation unit 33 can estimate (calculate) the distance by subtracting a value of the reception intensity from a value of the intensity of radio wave output and multiplying a resultant value by a predetermined constant, for example.

### <Detail of Process>

In the following, a process of the FAX transmission system 1 according to the third embodiment is described in detail. Since the third embodiment has the same process from address book information obtainment to FAX transmission as in the second embodiment, a description thereof is omitted.

<<Process to Obtain Communication Information>>

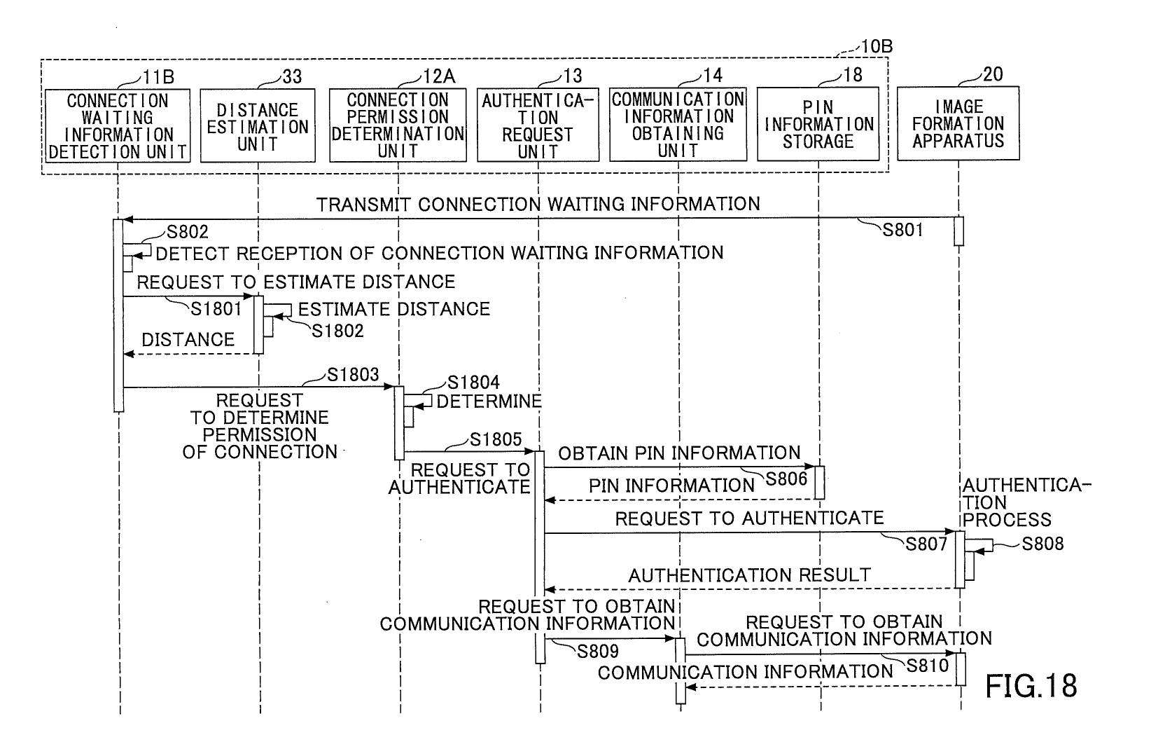

A process to obtain communication information from the image formation apparatus 20 by the mobile terminal 10B according to the third embodiment is described. FIG. 18 is a sequence diagram of the process to obtain communication information in the FAX transmission system 1 according to the third embodiment.

When the connection waiting information detection unit 11B of the mobile terminal 10B detects reception of connection waiting information, the connection waiting information detection unit 11B sends a request to estimate a distance based on the received connection waiting information to the distance estimation unit 33 (step S1801).

When the distance estimation unit 33 of the mobile terminal 10B receives the request to estimate a distance from the connection waiting information detection unit 11B, the distance estimation unit 33 estimates, based on the received connection waiting information, a distance between the mobile terminal 10B and the image formation apparatus 20 that transmitted the connection waiting information (step S1802). Then the distance estimation unit 33 sends information to indicate an estimated distance to the connection waiting information detection unit 11B.

When the connection waiting information detection unit 11B receives the information to indicate the distance estimated by the distance estimation unit 33, the connection waiting information detection unit 11B sends a request to determine connection permission to the connection permission determination unit 12A (step S1803). In addition, the request to determine connection permission includes the information to indicate the distance estimated by the distance estimation unit 33.

The connection permission determination unit 12A determines whether the distance estimated by the distance estimation unit 33 is not more than the first threshold (step S1804). Then the connection permission determination unit 12A sends an authentication request to the authentication request unit 13 in accordance with a determination result (step S1805). In other words, if the distance estimated by the distance estimation unit 33 is not more than the first threshold, the connection permission determination unit 12A sends an authentication request to the authentication request unit 13.

In accordance with this, even if there are a plurality of image formation apparatuses 20 disposed on the same floor, the mobile terminal 10B according to the present embodiment can obtain, with the first threshold that is appropriately set, the communication information 1000 from an appropriate image formation apparatus 20.

More specifically, if a distance between the mobile terminal 10B and the image formation apparatus 20-1 is not more than the first threshold, while a distance between the mobile terminal 10B and the image formation apparatus 20-2 is more than the first threshold, the mobile terminal 10B obtains the communication information 1000 from the image formation apparatus 20-1. Accordingly, as long as the first threshold is appropriately set based on a distance between image formation apparatuses 20 disposed on the floor, the mobile terminal 10B can obtain the address book information 2000 from a specific image formation apparatus 20 that the user wishes to use.

As mentioned above, the mobile terminal 10B according to the present embodiment obtains the communication information 1000 to obtain the address book information 2000 from the image formation apparatus 20 if the distance to the image formation apparatus 20 is not more than the first threshold.

<<Process to Delete Address Book Information>>

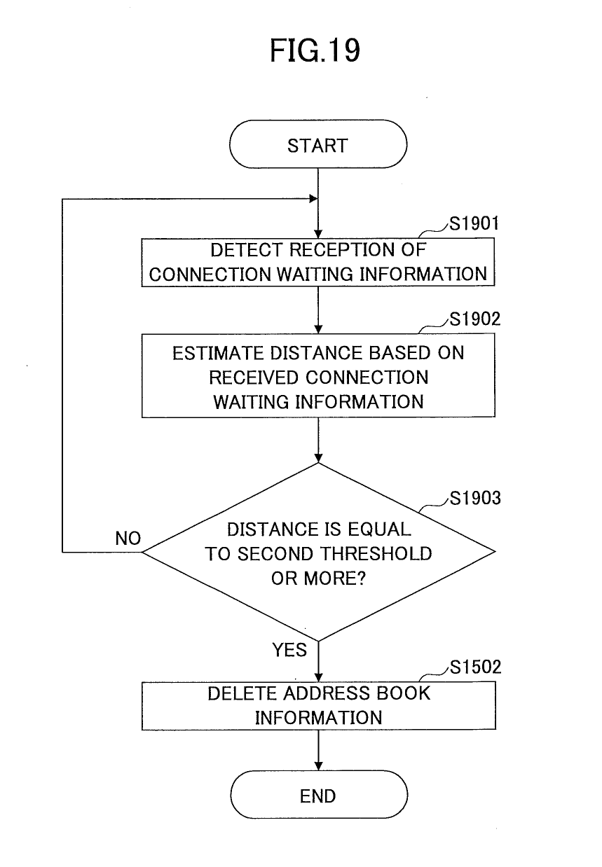

The following describes a process to delete the address book information 5000 stored in the mobile terminal 10B according to the present embodiment when the user ends the use of the image formation apparatus 20. FIG. 19 is a flowchart of the process to delete the address book information 5000 according to the third embodiment.

The connection waiting information detection unit 11B of the mobile terminal 10B detects reception of connection waiting information (step S1901).

In this case, the image formation apparatus 20 is transmitting connection waiting information within a predetermined area around the image formation apparatus 20 as described above. Accordingly, while the user is within the predetermined area around the image formation apparatus 20, the connection waiting information detection unit 11B of the mobile terminal 10B detects reception of the connection waiting information upon each reception of the connection waiting information.

When the reception of the connection waiting information is detected by the connection waiting information detection unit 11B, the distance estimation unit 33 of the mobile terminal 10B estimates, based on the received connection waiting information, a distance to the image formation apparatus 20 that transmitted the connection waiting information (step S1902).

When the distance to the image formation apparatus 20 that transmitted the connection waiting information is estimated by the distance estimation unit 33, the deletion unit 32A of the mobile terminal 10B determines whether the estimated distance is greater than or equal to the second threshold (step S1903).

If the deletion unit 32A determines that the distance is greater than or equal to the second threshold in step S1903 (S1903 YES), the mobile terminal 10B performs the process of step S1502. In other words, the deletion unit 32A deletes address book information stored in the address book information storage 31.

By contrast, if the deletion unit 32A determines that the distance is less than the second threshold in S1903 (S1903 NO), the process returns to step S1901.

In accordance with this, in the mobile terminal 10B according to the present embodiment, it is possible to delete the address book information 5000 based on the distance to the image formation apparatus 20 that transmitted the connection waiting information. In other words, if the user has moved away from the image formation apparatus 20 by a predetermined distance or more, the mobile terminal 10B according to the present embodiment can delete the address book information 5000 based on the fact that the use of the image formation apparatus 20 by the user has ended.

In addition, in the present embodiment, the first threshold and the second threshold may have values set in the image formation apparatus 20 by the administrator of the FAX transmission system 1, for example. In this case, the image formation apparatus 20 may include the first threshold and the second threshold set by the administrator in the connection waiting information or the like and transmit it to the mobile terminal 10B. In accordance with this, the administrator can flexibly set the thresholds such that the first threshold and the second threshold are set low in one image formation apparatus 20 having another image formation apparatuses 20 in its vicinity while the first threshold and the second threshold are set high in an image formation apparatus 20 having no other image formation apparatuses 20 in its vicinity, for example.

### <Conclusion>

As described above, the mobile terminal 10 according to the first embodiment can obtain, if the mobile terminal 10 is located in a communication area that enables communication in the first communication protocol, communication information via the first communication protocol from the image formation apparatus 20, the communication information being used to perform communication via the second communication protocol with the image formation apparatus 20.

Then the mobile terminal 10 according to the first embodiment can obtain, based on the communication information obtained via the first communication protocol, predetermined information such as address book information from the image formation apparatus 20 via the second communication protocol.

Accordingly, as long as the mobile terminal 10 according to the first embodiment is located in the communication area that enables communication via the first communication protocol with the image formation apparatus 20, the mobile terminal 10 can start obtaining address book information even or the like if the mobile terminal 10 is located away from the image formation apparatus 20. In accordance with this, when a user carrying the mobile terminal 10 has arrived in front of the image formation apparatus 20 in order to perform an image formation process such as FAX transmission, the address book information has been completely obtained. Accordingly, the user can start an operation to perform the image formation process without experiencing a waiting time. Even if the address book information has not been completely obtained when the user has arrived in front of the image formation apparatus 20, it is possible to reduce the waiting time to start the operation to perform the image formation process.

Further, after the address book information is obtained, if the mobile terminal 10A according to the second embodiment has moved to a location where communication via the first communication protocol with the image formation apparatus 20 is impossible, the mobile terminal 10A deletes the obtained address book information. In accordance with this, the mobile terminal 10A according to the second embodiment can delete unnecessary address book information.

Further, the mobile terminal 10B according to the third embodiment obtains and deletes the address book information based on a distance to the image formation apparatus 20. In accordance with this, even if a plurality of image formation apparatuses 20 are disposed on the floor, for example, the mobile terminal 10B according to the third embodiment can obtain address book information from an appropriate image formation apparatus 20. Further, the mobile terminal 10B according to the third embodiment can delete the address book information if the distance to the image formation apparatus 20 has become a predetermined value or more even within the communication area that enables communication via the first communication protocol with the image formation apparatus 20.

The connection waiting information detection unit 11 is an example of a detection unit. The connection permission determination unit 12 is an example of a determination unit. The communication information obtaining unit 14 is an example of a first information obtaining unit. The address book information obtaining unit 16 is an example of a second information obtaining unit. The authentication request unit 13 is an example of an authentication information transmission unit. The UI display unit 15 is an example of a selection screen display unit.

The present invention is not limited to the above-mentioned embodiments that are specifically described. Various types of variations and modifications of the present invention can be made without departing from the scope of the claims.

Further, the present invention is not limited to these embodiments, and various variations and modifications may be made without departing from the scope of the present invention.

What is claimed is:

1. A non-transitory computer-readable recording medium storing a computer-readable program that, when executed by an information processing apparatus to be connected with at least a device via a plurality of communication protocols, causes the information processing apparatus to serve as:
a detection unit that detects connection waiting information transmitted by the device, the connection waiting information being transmitted within a communication area that enables communication via a first communication protocol;
a determination unit that determines, when the detection unit detects the connection waiting information, whether the information processing apparatus is to be connected with the device that transmitted the connection waiting information;
a first information obtaining unit that connects, if the determination unit determines that the information processing apparatus is to be connected with the device that transmitted the connection waiting information, with the device via the first communication protocol and obtains communication information to communicate with the device via a second communication protocol, the device being connected via the first communication protocol; and
a second information obtaining unit that communicates with the device via the second communication protocol based on the communication information obtained by the first information obtaining unit, and obtains predetermined information from the device.

2. The non-transitory computer-readable recording medium as claimed in claim 1, further causing the information processing apparatus to serve as:
an authentication information transmission unit that transmits, if the determination unit determines that the information processing apparatus is to be connected with the device that transmitted the connection waiting information, authentication information to the device,
wherein if information that indicates successful authentication is received from the device to which the authentication information is transmitted by the authentication information transmission unit, the first information obtaining unit connects with the device via the first communication protocol and obtains the communication information to communicate with the device via the second communication protocol, the device being connected via the first communication protocol.

3. The non-transitory computer-readable recording medium as claimed in claim 1, further causing the information processing apparatus to serve as:
a selection screen display unit that displays a selection screen to select whether the information processing apparatus is to communicate with the device via the second communication protocol,
wherein if the information processing apparatus is to communicate with the device via the second communication protocol as a result of selection on the selection screen displayed by the selection screen display unit, the second information obtaining unit communicates with the device via the second communication protocol based on the communication information obtained by the first information obtaining unit, and obtains the predetermined information from the device.

4. The non-transitory computer-readable recording medium as claimed in claim 1, wherein the predetermined information includes information related to an address book including phone numbers of users, the non-transitory computer-readable recording medium further causing the information processing apparatus to serve as:
a FAX transmission request unit that sends, to the device in communication via the second communication protocol, a request for FAX transmission to a phone number selected from the information related to the address book.

5. The non-transitory computer-readable recording medium as claimed in claim 1, further causing the information processing apparatus to serve as:
a deletion unit that deletes the predetermined information obtained by the second information obtaining unit, wherein the deletion unit deletes the predetermined information if a distance between the information processing apparatus and the device in communication via the second communication protocol becomes a predetermined value or more.

6. The non-transitory computer-readable recording medium as claimed in claim 5, wherein
the predetermined information includes at least one user record and
the deletion unit deletes a user record selected to be deleted from the at least one user record included in the predetermined information.

7. The non-transitory computer-readable recording medium as claimed in claim 1, further causing the information processing apparatus to serve as:
a reception intensity calculation unit that calculates reception intensity of the connection waiting information received via the first communication protocol,
wherein the determination unit determines, based on the reception intensity calculated by the reception intensity calculation unit, whether the information processing apparatus is to be connected with the device that transmitted the connection waiting information.

8. The non-transitory computer-readable recording medium as claimed in claim 1, wherein the first communication protocol includes Bluetooth Low Energy (BLE).

9. An information processing apparatus to be connected with at least a device via a plurality of communication protocols, the information processing apparatus comprising:
a detection unit that detects connection waiting information transmitted by the device, the connection waiting information being transmitted within a communication area that enables communication via a first communication protocol;
a determination unit that determines, when the detection unit detects the connection waiting information, whether the information processing apparatus is to be connected with the device that transmitted the connection waiting information;
a first information obtaining unit that connects, if the determination unit determines that the information processing apparatus is to be connected with the device that transmitted the connection waiting information, with the device via the first communication protocol and obtains communication information to communicate with the device via a second communication protocol, the device being connected via the first communication protocol; and
a second information obtaining unit that communicates with the device via the second communication protocol based on the communication information obtained by the first information obtaining unit, and obtains predetermined information from the device.

10. The information processing apparatus as claimed in claim 9, further comprising:
an authentication information transmission unit that transmits, if the determination unit determines that the information processing apparatus is to be connected with the device that transmitted the connection waiting information, authentication information to the device,
wherein if information that indicates successful authentication is received from the device to which the authentication information is transmitted by the authentication information transmission unit, the first information obtaining unit connects with the device via the first communication protocol and obtains the communication information to communicate with the device via the second communication protocol, the device being connected via the first communication protocol.

11. The information processing apparatus as claimed in claim 9, further comprising:
a selection screen display unit that displays a selection screen to select whether the information processing apparatus is to communicate with the device via the second communication protocol,
wherein if the information processing apparatus is to communicate with the device via the second communication protocol as a result of selection on the selection screen displayed by the selection screen display unit, the second information obtaining unit communicates with the device via the second communication protocol based on the communication information obtained by the first information obtaining unit, and obtains the predetermined information from the device.

12. The information processing apparatus as claimed in claim 9, wherein the predetermined information includes information related to an address book including phone numbers of users, the information processing apparatus further comprising:
a process request unit that sends, to the device in communication via the second communication protocol, a request for FAX transmission to a phone number selected from the information related to the address book.

13. The information processing apparatus as claimed in claim 9, wherein the first communication protocol includes Bluetooth Low Energy (BLE).

14. An information processing system comprising:
at least a device;
an information processing apparatus to be connected with the device via a plurality of communication protocols;
a detection unit that detects connection waiting information transmitted by the device, the connection waiting information being transmitted within a communication area that enables communication via a first communication protocol;
a determination unit that determines, when the detection unit detects the connection waiting information, whether the information processing apparatus is to be connected with the device that transmitted the connection waiting information;
a first information obtaining unit that connects, if the determination unit determines that the information processing apparatus is to be connected with the device that transmitted the connection waiting information, with the device via the first communication protocol and obtains communication information to communicate with the device via a second communication protocol, the device being connected via the first communication protocol;
a second information obtaining unit that communicates with the device via the second communication protocol based on the communication information obtained by the first information obtaining unit, and obtains predetermined information from the device; and
a process request unit that sends, to the device in communication via the second communication protocol, a request for a predetermined process based on the predetermined information obtained by the second information obtaining unit.

15. The information processing system as claimed in claim 14, further comprising:
an authentication information transmission unit that transmits, if the determination unit determines that the information processing apparatus is to be connected with the device that transmitted the connection waiting information, authentication information to the device; and
an authentication result transmission unit that performs, upon receiving the authentication information transmitted by the authentication information transmission unit, authentication based on the authentication information, and, if the authentication is successful, transmits information that indicates successful authentication to the authentication information transmission unit,
wherein when the information that indicates successful authentication is received from the device to which the authentication information transmission unit transmitted the authentication information, the first information obtaining unit connects with the device via the first communication protocol and obtains the communication information to communicate with the device via the second communication protocol, the device being connected via the first communication protocol.
